(19) United States
(12) Patent Application Publication
(10) Pub. No.: US 2024/0415067 A1
(43) Pub. Date: Dec. 19, 2024

(54) Tree injection device

(71) Applicant: Dieu Huyen Nguyen, Atlanta, GA (US)

(72) Inventor: Dieu Huyen Nguyen, Atlanta, GA (US)

(21) Appl. No.: 18/210,106

(22) Filed: Jun. 15, 2023

(51) Int. Cl. A01G 7/06

(52) U.S. Cl. CPC A01G 7/06

(57) ABSTRACT

The tree injection device comprises a bottle with a cap connected to an elastic tube and an injector with a press-to-open valve. The device allows refilling of solution and re-pumping to desired pressure. Insertion of the injector into a drilled hole in the tree's trunk opens the valve to automatically start injection.

### CLASSIFICATIONS

A01G7/06-Treatment of growing trees or plants, e.g. for preventing decay of wood, for tingeing flowers or wood, for prolonging the life of plants

### CROSS-REFERENCE TO RELATED APPLICATIONS

Not Applicable.

### BACKGROUND OF THE INVENTION

Tree injection is an effective and environmentally friendly method for treating various plant diseases and insects. Many devices have been invented for tree injection. Currently, citrus greening has spread worldwide, forcing farmers to treat all citrus trees in a farm within limited time windows. This requires a high-volume, low-cost device for plant injection. High-volume solution allows injecting lower concentrations of chemicals that may have less harmful effects on plants. However, it also increases the pressure on the treatment time.

This invention provides a low-cost device and method for plant injection that aims to solve the problem faced by the citrus industry and similar industries.

### SUMMARY OF THE INVENTION

The device consists of a bottle and a plastic tube connected to the bottle over its cap. The other end of the tube is connected to an injector with or without wings for pressing and screwing. The drill hole in a tree has a predetermined depth. Solution is poured into the bottle up to a maximum of ½ volume of the bottle. A compressor or a handpump is used to bring the pressure in the bottle to the level required by the type of tree or by the time required to complete injection. Higher pressure results in quicker infusion time but may harm the tree and risk blasting the bottle.

The injector has a touching valve, which keeps the air/solution inside the device. The valve may be secured for transportation by a cap or valve screw. Once inserted into the drilled hole in a tree, the exposed part of the valve presses to the bottom of the hole and releases the solution from the bottle which is hung higher than the drill hole with rope or similar.

The device is simple and can use recycled PET bottles like Coca-Cola or Pepsi-Cola ones. A number of devices can be loaded with injection solution and compressed air in a workshop, brought to the plantation for injection, and collected back to the workshop for refill. Installation time for one device is also very short due to simple operation: Hang, Drill, Plug and go.

### DESCRIPTION OF THE DRAWINGS

Other objects, features, and advantages will occur to those skilled in the art from the following description and the accompanying drawings in which:

FIG. 1: A side view of the injection system fully installed in a tree.

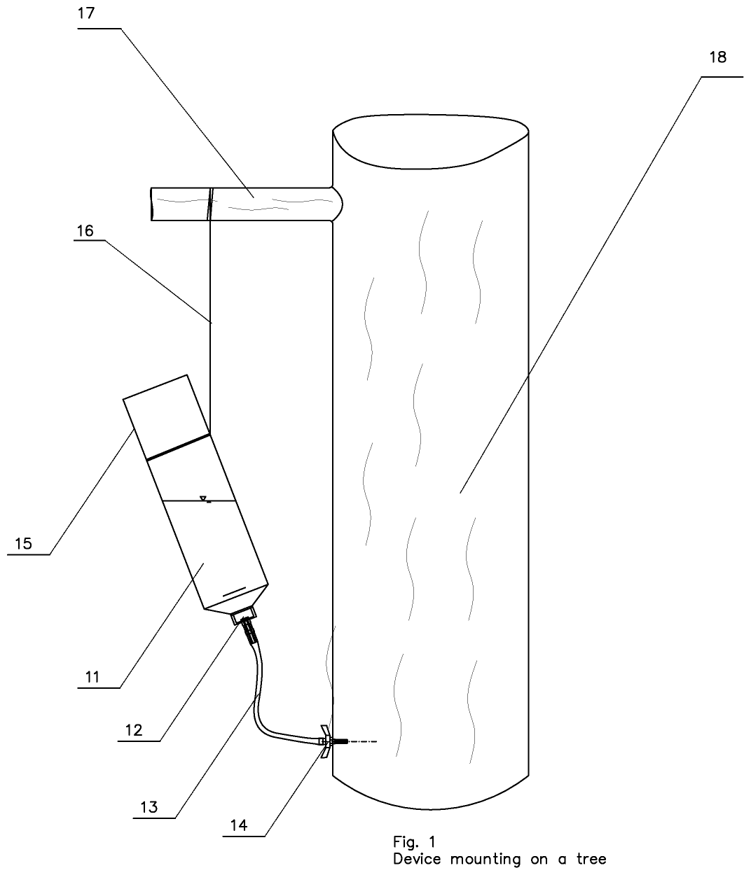

FIG. 2: A side view of the system during loading injection solution into the bottle and pumping up the bottle to required pressure through the valve.

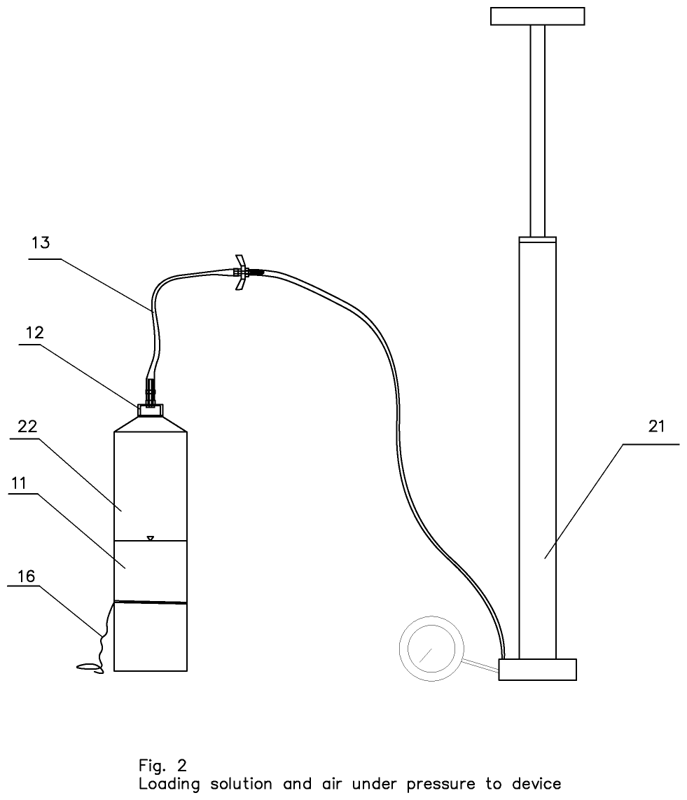

FIG. 3: A detailed cross section view of bottle cap connection with elastic tube.

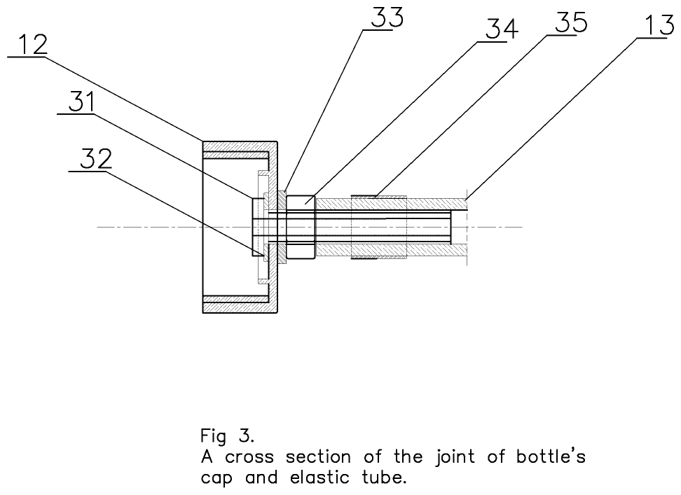

FIG. 4: A side view of the injector of the plant injection system that shows how the valve is constructed.

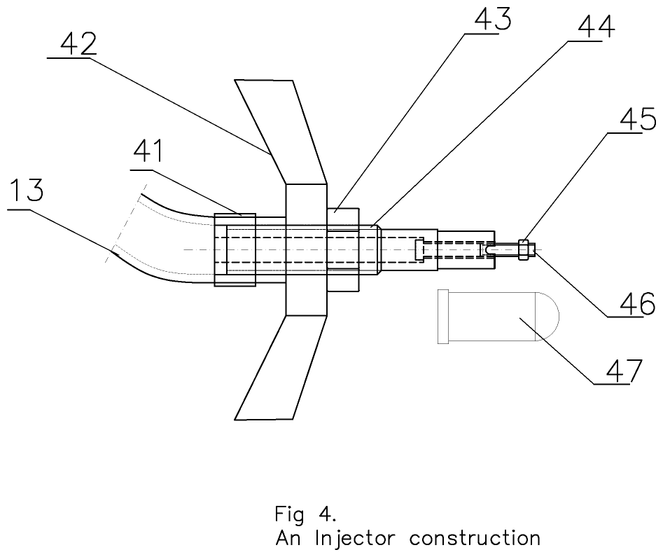

FIG. 5: A detailed view of an injector housed in a drilled hole on a trunk.

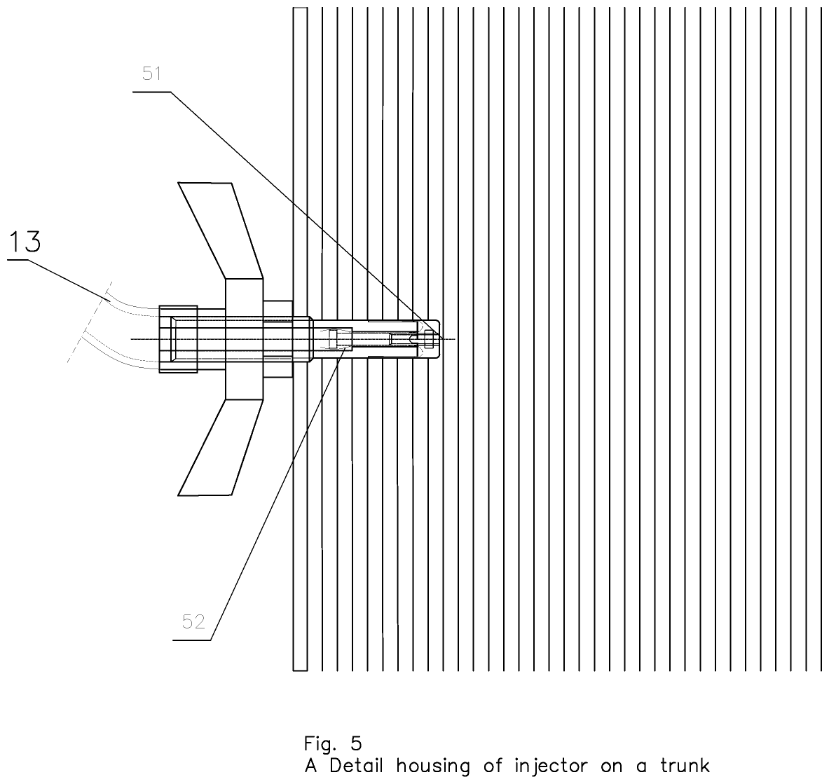

### DETAILED DESCRIPTION OF THE INVENTION

The device for plant injection generally comprises a bottle 15 or similar that can hold enough solution for a plant injection 11 and can hang from any tree branch 17 with a simple elastic rope 16. The bottle is filled with injection solution 11 and closed with a cap 12 which has a plastic pipe 13 that delivers solution to a connected injector. The cap 12 is bored, and the hollow bolt 31, washer sealer 32, washer 33 and nut 34 make an airtight solution delivery to the injector. The injector generally comprises wings 42 for better pressing and screwing, an injector body with threads that allow screwing into the tree to an adequate depth, and a separate ring 35 and 41 for keeping the plastic pipe 13 in place. The actuator 46 closes the channel for solution to run out of injector thanks to the high pressure inside the bottle. During load time, after filling in the bottle with solution and closing the cap, higher air pressure from a hand pump or compressor will open the valve and allow air to get into the bottle and bring the inside pressure to a predetermined level.

The tree trunk is drilled with predetermined depth with a drill bit which has diameter same as thread hole defined by injector. Inserting the injector into the hole presses off the actuator on the bottom of the drilled hole 51 and opens the valve for solution to start injection as indicated by 52.

The injector may include screw 45 for securing pressurized solution in the bottle for transport and cap 47 for the same reason.

I claim:

1. A tree injection device, comprising:
a bottle connected with an elongated tube through its cap;
an injector connected to the other end of the tube.

2. The tree injection device of claim 1, further comprising:
a fastener that removably secures the device to a tree.

3. The tree injection device of claim 1, wherein:
the injector has a press-to-open valve that opens on pressing or when outside pressure is higher than inside bottle pressure.

4. The tree injection device of claim 3, wherein:
The injector has fine threaded exterior and wing for pressing and screwing into a drilled hole.

5. The tree injection device of claim 3, wherein:
The injector has screw and/or cap to secure valve for transport.

6. A method of injecting a tree, comprising:
Filling half of bottle with an injection solution;
Closing bottle with cap connected to tube and further to injector;
Connecting injector to hand pump or compressor and filling compressed air into bottle;
Hanging bottle in an anticipated working position with rope;
Drilling trunk tree with a drill bit with depth limiter;
Inserting injector into hole to full depth until valve opens and injection starts.
